(19) United States
(12) Patent Application Publication
(10) Pub. No.: US 2023/0289612 A1
(43) Pub. Date: Sep. 14, 2023

(54) REINFORCEMENT LEARNING WITH OPTIMIZATION-BASED POLICY

(71) Applicant: VIRGINIA TECH INTELLECTUAL PROPERTIES, INC., Blacksburg, VA (US)

(72) Inventor: Ming Jin, Blacksburg, VA (US)

(21) Appl. No.: 18/181,048

(22) Filed: Mar. 9, 2023

Related U.S. Application Data
(60) Provisional application No. 63/318,988, filed on Mar. 11, 2022.

(51) Int. Cl. G06N 3/092

(52) U.S. Cl. CPC G06N 3/092

(57) ABSTRACT

Concepts of using optimization-based policy in reinforcement learning (RL) are described. In one example, a method can include implementing an RL agent in a subsystem of the sequential decision-making system. The RL agent can be coupled to a prediction module and an optimization module of the subsystem. The method can also include defining a parameter value of the optimization module based on an observed state of the subsystem and/or a reward provided to the prediction module based on the observed state. The method can also include learning a policy that is defined by the optimization module based on the parameter value and a predicted future state of the subsystem that is predicted by the prediction module based on the reward. The policy can include a suggested action to be performed by the subsystem to achieve a goal. The method can also include implementing the policy to perform the suggested action.

### CROSS-REFERENCE TO RELATED APPLICATION

This application claims the benefit of and priority to U.S. Provisional Patent Application No. 63/318,988, titled “Reinforcement Learning with Optimization-Based Policy,” filed Mar. 11, 2022, the entire contents of which is hereby incorporated by reference herein.

### BACKGROUND

Sequential decision-making problems appear in numerous domains, such as energy, supply chain management, finance, health, and robotics, among others. These applications are often required to make decisions under uncertainty that may be attributed to various factors such as dynamic environments and human interventions. For example, such uncertainty may arise in the form of uncertain demands of electricity, goods, changing prices, and unstable weather, among others. One such class of sequential decision-making problems involve distributed control systems, where the objective is to control several systems to achieve a desired goal while adhering to domain-specific constraints. Reinforcement learning agents are currently used in such systems to explore and exploit the relatively best control, coordination, or planning strategy to achieve the desired goal.

Optimal control and stochastic optimal control are also well-known approaches to sequential decision-making problems. Various large-scale stochastic programs can deal with future uncertainty. Optimization, especially convex optimization, has become the de facto standard in industrial systems with profound theoretical foundations and various formulations for control and planning applications. Such approaches can easily encode domain-specific constraints, for example, in the form of nonlinear functions and variational inequalities and can gracefully handle problems with millions of decision variables. Optimization models and methods are often implemented in systems that involve sequential decision-making problems such as distributed control systems to address emerging issues in the deployment of proper control, coordination, or planning strategies.

### SUMMARY

The present disclosure is directed to dynamic and intelligent reinforcement learning with optimization-based policy for one or more subsystems of a sequential decision-making system such as, for instance, a distributed control system (DCS). More specifically, described herein is an adaptive optimization framework that can be embodied or implemented as a software architecture to adapt an optimization module based on real-world conditions using a reinforcement learning (RL) agent and policy actions generated by the optimization module. In particular, the RL agent can learn how to adapt the optimization module toward generating the relatively best policy actions for achieving a defined goal in connection with performing sequential decision-making operations.

According to an example of the adaptive optimization framework described herein, a computing device can implement an RL agent in a subsystem of a sequential decision-making system. The RL agent can be coupled to a prediction module and an optimization module of the subsystem. The computing device can define a parameter value of the optimization module based on at least one of an observed state of the subsystem or a reward provided to the prediction module based on the observed state. The computing device can learn a policy that is defined by the optimization module based on the parameter value and a predicted future state of the subsystem that is predicted by the prediction module based on the reward. The policy can include one or more suggested actions to be performed by the subsystem to achieve a defined goal. The computing device can then implement the policy to cause the subsystem to perform the one or more suggested actions.

Additionally, the computing device can implement the RL agent to learn the parameter value based on domain-specific data associated with a domain of at least one of the sequential decision-making system or the subsystem. To learn the parameter value based on such domain-specific data, the RL agent can implement an evolutionary search algorithm that uses a guidance function to define the parameter value based on the domain-specific data. In this way, the adaptive optimization framework of the present disclosure can facilitate the dynamic, intelligent, and online adaptation of the optimization module based on real-world conditions and domain-specific data to allow the subsystem to achieve one or more defined goals in performing sequential decision-making operations.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example environment that can facilitate reinforcement learning with optimization-based policy for a sequential decision-making system according to at least one embodiment of the present disclosure.

FIG. 2 illustrates a block diagram of an example the computing environment that can facilitate reinforcement learning with optimization-based policy for a sequential decision-making system according to at least one embodiment of the present disclosure.

FIG. 3 illustrates an example data flow that can be implemented to facilitate reinforcement learning with optimization-based policy for a sequential decision-making system according to at least one embodiment of the present disclosure.

FIG. 4 illustrates a diagram of example parameter value exploration operations that can be implemented to facilitate reinforcement learning with optimization-based policy for a sequential decision-making system according to at least one embodiment of the present disclosure.

FIG. 5 illustrates a block diagram of an example adaptive optimization system that can facilitate reinforcement learning with optimization-based policy for a sequential decision-making system according to at least one embodiment of the present disclosure.

FIG. 6 illustrates an example correspondence diagram according to at least one embodiment of the present disclosure.

FIG. 7 illustrates a flow diagram of an example computer-implemented method that can be implemented to facilitate reinforcement learning with optimization-based policy for a sequential decision-making system according to at least one embodiment of the present disclosure.

### DETAILED DESCRIPTION

Optimization and RL are often implemented in sequential decision-making systems such as a DCS to address everchanging real-world conditions in the deployment of proper control, coordination, or planning strategies. However, a problem with implementing optimization in such sequential decision-making systems is that, once built, optimization models do not adapt to the changing real-world conditions or fast evolving data streams. Such rigidness may lead to higher cost and even unsafe scenarios, rendering such optimization model-based approaches inadequate for modern sequential decision-making systems.

A problem with existing RL models is that they require a relatively large amount of data samples to learn useful information or data. Another problem with existing RL models is that they utilize control methods that only work with a finite amount of state and action data, and thus, they only accommodate a corresponding finite number of data dimensions. Another problem with some existing RL models is that they achieve a single objective and are not adaptable to achieve multiple, different objectives. As such, these existing RL models are not very effective when applied in sequential decision-making systems.

Another problem with existing RL models is that they may violate domain-specific constraints, such as safety constraints and resource constraints, as there are limitations with encoding such constraints in connection with such existing RL models. Another problem with some existing RL models is that even though they use relatively high dimensional functions such as neural networks, they are not explainable.

The present disclosure provides solutions to address the above-described problems associated with effectively and efficiently implementing optimization and RL in sequential decision-making systems in general and with respect to the approaches used by existing technologies. For example, the adaptive optimization framework described herein can be effectively implemented in an online setting without the use of any data samples, as it can employ optimization technology that can be effectively applied without any learning.

Additionally, the adaptive optimization framework is scalable and adaptable to a variety of domains and sequential decision-making systems, as it can employ various optimization technologies that can accommodate continuous state and action data associated with relatively high dimensional systems. The adaptive optimization framework is also scalable and adaptable because it can employ a multi-objective optimization technology that allows for the adaptive optimization framework to achieve multiple, different objectives.

In addition, the adaptive optimization framework can employ a constraint optimization technology that allows for the encoding of any constraint that is to be satisfied in any decision process, thereby providing for the reliable and safe implementation of sequential decision-making systems in a variety of domains. Also, the optimization technology described herein that can be employed by the adaptive optimization framework is both interpretable and explainable, thereby providing further reliability and safety in implementing sequential decision-making systems in a variety of domains.

The adaptive optimization framework of the present disclosure provides several technical benefits and advantages. For example, the adaptive optimization framework can be implemented in an online environment without an extensive training period, which is particularly advantageous in a real-world setting where an offline environment for model training is usually not available. As such, the adaptive optimization framework can reduce the time and costs (e.g., computational costs) associated with training an RL model implemented in a sequential decision-making system.

The adaptive optimization framework can also improve the efficiency and reduce computational costs of subsystems implementing sequential decision-making operations in a sequential decision-making system. For instance, the adaptive optimization framework can provide for the generation of policy actions that can allow such subsystems to achieve a defined level of individual or collective efficiency in performing such operations, thereby reducing computational costs of any or all of such subsystems.

In addition, the adaptive optimization framework can improve the efficiency and reduce computational costs associated with learning how to adapt the policy actions based on everchanging real-world conditions. For example, the adaptive optimization framework can use domain-specific data to effectively narrow the number of variables evaluated when learning how to adapt the policy actions. In this way, the adaptive optimization framework can thereby improve the efficiency and reduce the computational costs of a computing device tasked with evaluating such variables.

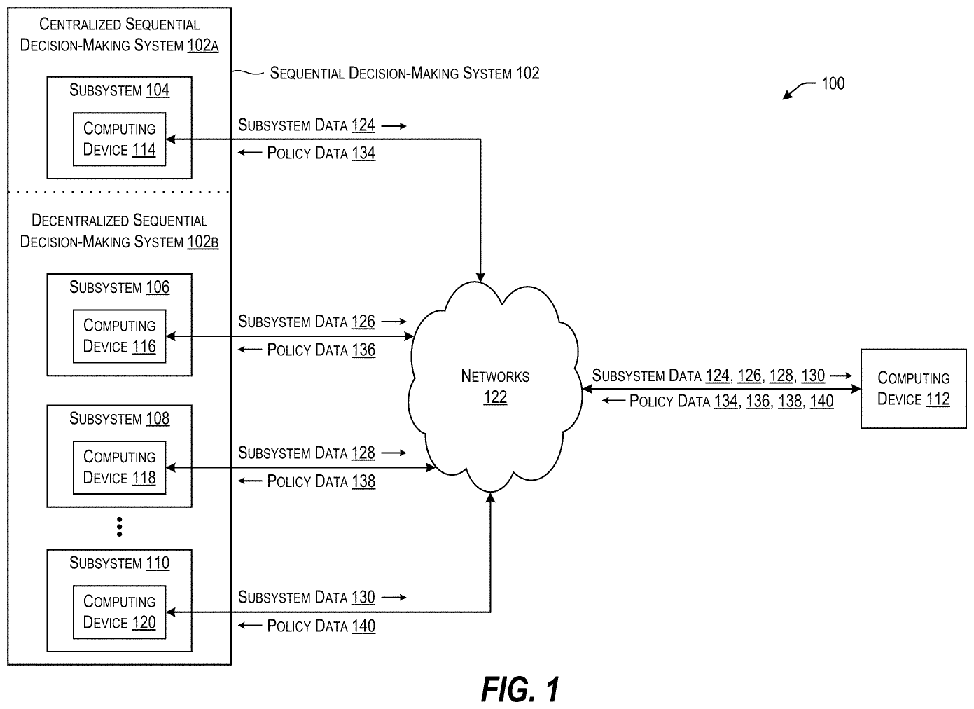

For context, FIG. 1 illustrates a block diagram of an example environment 100 that can facilitate reinforcement learning with optimization-based policy for a sequential decision-making system according to at least one embodiment of the present disclosure. In the example illustrated in FIG. 1, the environment 100 can be an environment in which sequential decision-making operations are performed by at least one of a sequential decision-making system or one or more subsystems thereof. However, the adaptive optimization framework of the present disclosure is not limited to such an environment.

As illustrated in FIG. 1, the environment 100 can include a sequential decision-making system 102. The sequential decision-making system 102 can include at least one of a centralized sequential decision-making system 102a or a decentralized sequential decision-making system 102b.

The centralized sequential decision-making system 102a can include a subsystem 104 that can perform sequential decision-making operations to achieve a defined goal. In some cases, the subsystem 104 can perform such operations independently using at least one of local data or information. In other cases, the subsystem 104 can perform such operations semi-independently using at least one of data or information provided by at least one of another system or computing device.

In one example, the centralized sequential decision-making system 102a can be embodied or implemented as a building management system that can control one or more subsystems of a building. In this example, the subsystem 104 can be embodied or implemented as a building energy management subsystem of such a building management system. For example, the subsystem 104 can be embodied or implemented as a building energy storage and discharge system that can perform sequential decision-making operations based on real-world conditions to, for instance, store and discharge energy for a building while achieving a certain level of efficiency.

The decentralized sequential decision-making system 102b can include multiple subsystems 106, 108, 110, among possibly others, that can each perform sequential decision-making operations to achieve a defined goal individually, collectively, or both. In some cases, each of the subsystems 106, 108, 110 can perform such operations independently using at least one of their respective local data or information. In other cases, each of the subsystems 106, 108, 110 can perform such operations semi-independently using at least one of global data or information provided by at least one of another system or computing device.

In one example, the decentralized sequential decision-making system 102b can be embodied or implemented as an industrial control system (ICS) such as, for instance, a DCS. For instance, the decentralized sequential decision-making system 102b can be embodied or implemented as an industrial management system or another type of ICS or DCS. In some cases, the decentralized sequential decision-making system 102b can be used to control various subsystems in a digitally automated or semi-automated manner.

In one example, the decentralized sequential decision-making system 102b can be embodied or implemented as an industrial management system that can be used to control various subsystems of an industrial system such as, for instance, a city, an industrial facility, a supply chain management system, or another type of industrial system. For instance, the decentralized sequential decision-making system 102b can be embodied or implemented as an industrial energy management system that can be used to control various industrial energy management subsystems of the industrial energy management system. In this example, each of the subsystems 106, 108, 110 can be embodied or implemented as such an industrial energy management subsystem.

In one example, each of the subsystems 106, 108, 110 can be embodied or implemented as a building energy management system of a certain building in an industrial system such as, for instance, a city or another industrial system. In this example, the subsystems 106, 108, 110 can perform sequential decision-making operations, individually or collectively, based on real-world conditions. The real-world conditions can be observed by any or all of the subsystems 106, 108, 110. In this example, the subsystems 106, 108, 110 can individually or collectively perform sequential decision-making operations to, for instance, store and discharge energy for each of their respective buildings while achieving a certain level of individual efficiency, collective efficiency, or both. In other words, the subsystems 106, 108, 110 can perform such operations, individually or collectively, to individually achieve a certain level of efficiency, collectively achieve a certain level of efficiency, or both.

As illustrated in FIG. 1, each of the subsystems 104, 106, 108, 110 can include a computing device 114, 116, 118, 120, respectively. Each of the computing devices 114, 116, 118, 120 can be embodied or implemented as, for example, a client computing device, a peripheral computing device, or both. Examples of each of the computing devices 114, 116, 118, 120 can include a computer, a general-purpose computer, a special-purpose computer, a laptop, a tablet, a smartphone, another client computing device, or any combination thereof. Each of the computing devices 114, 116, 118, 120 can be operatively coupled, communicatively coupled, or both, to their respective subsystem 104, 106, 108, 110. In this way, each of the computing devices 114, 116, 118, 120 can instruct their corresponding subsystem 104, 106, 108, 110 to perform operations and then observe the resulting states of their respective subsystem 104, 106, 108, 110 after they perform such operations.

In the example illustrated in FIG. 1, the environment 100 can further include a computing device 112. The computing device 112 can be communicatively coupled, operatively coupled, or both, to any or all of the computing devices 114, 116, 118, 120 by way of one or more networks 122 (hereinafter, “the networks 122”). The computing device 112 can be embodied or implemented as, for instance, a server computing device, a virtual machine, a supercomputer, a quantum computer or processor, another type of computing device, or any combination thereof. In one example, the computing device 112 can be associated with a data center, physically located at such a data center, or both.

The networks 122 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing devices 112, 114, 116, 118, 120 can communicate data with one another over the networks 122 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 122, without limitation. Although not illustrated, the networks 122 can also include connections to any number of other network hosts, such as website servers, file servers, networked computing resources, databases, data stores, or other network or computing architectures in some cases.

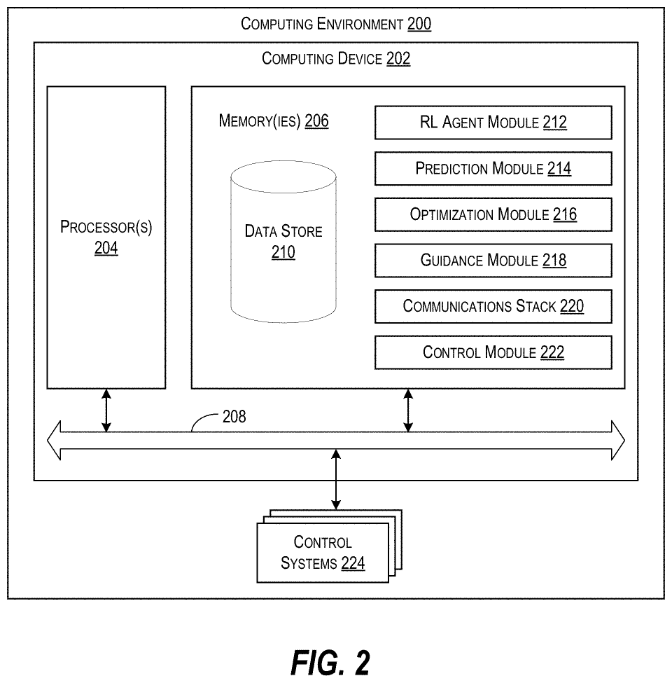

As described in detail with reference to the examples depicted in FIGS. 2, 3, 4, 5, and 6, each of the computing devices 112, 114, 116, 118, 120 can implement one or more aspects of the adaptive optimization framework of the present disclosure in accordance at least one of such examples. More specifically, the computing device 114 can implement one or more aspects of the adaptive optimization framework to provide reinforcement learning with optimization-based policy for the centralized sequential decision-making system 102a. Similarly, each of the computing devices 116, 118, 120 can implement one or more aspects of the adaptive optimization framework to provide reinforcement learning with optimization-based policy for the decentralized sequential decision-making system 102b. Likewise, in some cases, the computing device 112 can implement one or more aspects of the adaptive optimization framework to provide reinforcement learning with optimization-based policy for the centralized sequential decision-making system 102a, the decentralized sequential decision-making system 102b, or both.

As described above, in one example, the centralized sequential decision-making system 102a can be a building management system and the subsystem 104 can be a building energy management subsystem of such a system. For instance, the subsystem 104 can be a building energy storage and discharge system. In this example, the subsystem 104 can perform sequential decision-making operations based on real-world conditions to, for example, store and discharge energy for a building while achieving a defined goal such as, for instance, a certain level of efficiency. In this example, the computing device 114 can implement one or more aspects of the adaptive optimization framework described herein to perform such sequential decision-making operations based on the real-world conditions to store and discharge energy for the building while achieving a defined level of efficiency. In this example, to perform such operations based on real-world conditions while achieving a defined level of efficiency, the computing device 114 can include and also implement an RL agent based on optimization policy.

In particular, in the example above, the computing device 114 can implement the RL agent using a solution function of an optimization module as policy. For instance, the computing device 114 can implement the RL agent using a solution function of an optimization module as a policy function. In this example, the computing device 114 can include and also implement the optimization module. In some cases, the solution function can be an optimized objective function having the relatively best variable and/or constraint values that facilitate achieving a defined goal. The computing device 114 can use the policy or multiple policies to recommend actions for the above-described sequential decision-making operations associated with storing and discharging energy that can be performed by the subsystem 104.

In the example above, the computing device 114 can further implement the RL agent using the policy or multiple policies to learn how to adapt the optimization module based on real-world conditions. For instance, the computing device 114 can learn how to adapt the optimization module such that the subsystem 104 can perform such sequential decision-making operations based on real-world conditions while achieving the defined level of efficiency. In one example, the computing device 114 can implement the RL agent using multiple, different policies to learn how to adapt the optimization module based on observed states of the subsystem 104. In this example, the observed states are observed after the subsystem 104 performs such sequential decision-making operations based on at least one recommended action of at least one of the different policies.

In some cases, the computing device 114 can learn how to adapt the optimization module based on observed states of the subsystem 104 by iteratively adjusting (also referred to as “tuning”) one or more parameters of the optimization module based on the observed states. In this way, the computing device 114 can learn a set of parameters and corresponding parameter values that allow the optimization module to define a policy of one or more suggested actions for sequential decision-making operations such that the subsystem 104 can perform these operations while achieving a defined level of efficiency.

In some cases, the computing device 112 can implement one or more aspects of the adaptive optimization framework of the present disclosure in accordance with at least one example described herein. For example, the computing device 114 can offload at least some of its processing workload to the computing device 112 via the networks 122.

In one example, the computing device 112 can use subsystem data 124 provided by the computing device 114 to generate policy data 134 for the computing device 114. In this example, the subsystem data 124 can be indicative of, include, or both indicate and include the observed states of the subsystem 104 that can be observed after the subsystem 104 performs the above-described sequential decision-making operations associated with storing and discharging energy. The policy data 134 can be indicative of, include, or both, at least one policy that can each include one or more recommended actions for the subsystem 104 to perform in connection with such operations. For example, the policy data 134 can be indicative of, include, or both, at least one policy that can each include one or more recommended actions that allow the subsystem 104 to perform such operations based on real-world conditions while allowing for the subsystem 104 to achieve a defined level of efficiency.

In the example above, the computing device 112 can include the above-described RL agent based on optimization policy and the above-described optimization module. In this example, the computing device 112 can use the subsystem data 124 to implement its RL agent based on optimization policy and its optimization module in the same manner as the computing device 114 to generate the policy data 134.

In the example above, the computing device 112 can further implement its RL agent using the subsystem data 124 and the policy data 134 to learn how to adapt its optimization module based on real-world conditions in the same manner as the computing device 114. For instance, the computing device 112 can learn how to adapt its optimization module in the same manner as the computing device 114 such that the subsystem 104 can perform sequential decision-making operations based on real-world conditions while achieving a defined level of efficiency. For example, the computing device 112 can learn how to adapt its optimization module by iteratively adjusting (tuning) one or more parameters of its optimization module based on the subsystem data 124 and the policy data 134. In this way, the computing device 112 can learn a set of parameters and corresponding parameter values that allow its optimization module to define the policy data 134 for sequential decision-making operations such that the subsystem 104 can perform these operations while achieving a defined level of efficiency. As such, the computing device 112 can thereby effectively also learn the policy data 134 over time.

As described above, in one example, the decentralized sequential decision-making system 102b can be an industrial energy management system and each of the subsystems 106, 108, 110 can be a building energy management system that is a subsystem of the industrial energy management system. In this example, the subsystems 106, 108, 110 can perform sequential decision-making operations, individually or collectively, based on real-world conditions that can be experienced by any or all of the subsystems 106, 108, 110. The subsystems 106, 108, 110 can perform such operations individually or collectively to store and discharge energy for each of their respective buildings while achieving a certain level of individual efficiency, collective efficiency, or both.

In the example above, to individually or collectively perform such sequential decision-making operations based on real-world conditions, the computing devices 116, 118, 120 can respectively compile subsystem data 126, 128, 130. The subsystem data 126, 128, 130 can be indicative of, include, or both, the observed states of the subsystems 106, 108, 110, respectively. In this example, the observed states of the subsystems 106, 108, 110 can be observed after the subsystems 106, 108, 110 individually or collectively perform the above-described sequential decision-making operations associated with storing and discharging energy. In this example, the computing devices 116, 118, 120 can respectively share the subsystem data 126, 128, 130 with one another using the networks 122. In some cases, the computing devices 116, 118, 120 can respectively share the subsystem data 126, 128, 130 with the computing device 112 using the networks 122.

In the example above, each of the computing devices 116, 118, 120 can implement one or more aspects of the adaptive optimization framework described herein to perform such sequential decision-making operations based on the real-world conditions. For instance, the computing devices 116, 118, 120 can perform sequential decision-making operations individually or collectively based on the real-world conditions to store and discharge energy for their respective buildings while achieving a defined level of individual and/or collective efficiency. To individually or collectively perform such operations based on real-world conditions while achieving a defined level of individual and/or collective efficiency, each of the computing devices 116, 118, 120 can include and also implement the above-described RL agent based on optimization policy.

As one particular example, each of the computing devices 116, 118, 120 can use at least one of the subsystem data 126, 128, 130 to implement their respective RL agent using a solution function of an optimization module as policy. The computing devices 116, 118, 120 can each include and also implement the optimization module using at least one of the subsystem data 126, 128, 130. In some cases, each solution function can be an optimized objective function having the relatively best variable and/or constraint values that facilitate achieving a defined goal, individually or collectively. The computing devices 116, 118, 120 can each use their respective policy or policies to recommend actions for the above-described sequential decision-making operations associated with storing and discharging energy that can be performed individually or collectively by the subsystems 106, 108, 110.

Each of the computing devices 116, 118, 120 can further use at least one of the subsystem data 126, 128, 130 to implement their RL agent using their policy or policies to learn how to adapt their optimization module based on real-world conditions. For instance, the computing devices 116, 118, 120 can each learn how to adapt their optimization module such that the subsystems 106, 108, 110 can individually or collectively perform such sequential decision-making operations based on real-world conditions while achieving the defined level of individual and/or collective efficiency. In one example, the computing devices 116, 118, 120 can each implement their RL agent using at least one of the subsystem data 126, 128, 130 and their own different policies to learn how to adapt their optimization module based on observed states of the subsystems 106, 108, 110. In this example, the observed states are observed after the subsystems 106, 108, 110 individually or collectively perform such sequential decision-making operations based on at least one recommended action of at least one of their respective policies.

In some cases, each of the computing devices 116, 118, 120 can use at least one of the subsystem data 126, 128, 130 to learn how to adapt their optimization module based on observed states of the subsystems 106, 108, 110 by iteratively adjusting (tuning) one or more parameters of their optimization module based on the observed states. In this way, each of the computing devices 116, 118, 120 can learn a set of parameters and corresponding parameter values that allow their optimization module to define a policy of one or more suggested actions for sequential decision-making operations such that the subsystems 106, 108, 110 can perform these operations individually or collectively while achieving a defined level of individual and/or collective efficiency.

In some cases, any or all of the computing devices 116, 118, 120 can offload at least some of their respective processing workloads to the computing device 112 by way of the networks 122. In one example, the computing device 112 can use at least one of the subsystem data 126, 128, 130 to respectively generate at least one of policy data 136, 138, 140 for at least one of the computing devices 116, 118, 120.

Each of the policy data 136, 138, 140 can be indicative of, include, or both, at least one policy that can each include one or more recommended actions for the corresponding subsystem 106, 108, 110 to perform. For instance, the one or more recommended actions can include a suggested action that facilitates the above-described sequential decision-making operations associated with storing and discharging energy, individually or collectively. The recommended actions can include a suggested action that allows the corresponding subsystem 106, 108, 110 to perform such operations individually or collectively based on real-world conditions while allowing for the subsystems 106, 108, 110 to achieve a defined level of individual and/or collective efficiency.

The computing device 112 can include the above-described RL agent based on optimization policy and the above-described optimization module. In this example, the computing device 112 can use at least one of the subsystem data 126, 128, 130 to implement its RL agent based on optimization policy and its optimization module in the same manner as the computing device 114 to generate the policy data 134.

The computing device 112 can further implement its RL agent using at least one of the subsystem data 126, 128, 130 and at least one of the policy data 136, 138, 140 to learn how to adapt its optimization module based on real-world conditions in the same manner as the computing device 114. For instance, the computing device 112 can learn how to adapt its optimization module in the same manner as the computing device 114 such that the subsystems 106, 108, 110 can individually or collectively perform sequential decision-making operations based on real-world conditions while achieving a defined level of individual and/or collective efficiency.

The computing device 112 can also learn how to adapt its optimization module by iteratively adjusting or tuning one or more parameters of its optimization module based on at least one of the subsystem data 126, 128, 130 and at least one of the policy data 136, 138, 140. In this way, the computing device 112 can learn a set of parameters and corresponding parameter values that allow its optimization module to define at least one of the policy data 136, 138, 140 for sequential decision-making operations such at least one of the subsystems 106, 108, 110 can perform these operations while achieving a defined level of individual and/or collective efficiency. As such, the computing device 112 can thereby effectively also learn at least one of the policy data 136, 138, 140 over time.

FIG. 2 illustrates a block diagram of an example the computing environment 200 that can facilitate reinforcement learning with optimization-based policy for a sequential decision-making system. The computing environment 200 can include, be coupled to, or both, a computing device 202. For instance, the computing environment 200 can include and/or be at least one of communicatively coupled or operatively coupled to the computing device 202.

With reference to FIGS. 1 and 2 collectively, in the examples described herein, the computing environment 200 can be used, at least in part, to embody or implement any of the subsystems 104, 106, 108, 110. In these examples, the computing device 202 can be used, at least in part, to embody or implement any of the computing devices 112, 114, 116, 118, 120. In an example where the computing device 112 can be associated with a data center, physically located at such a data center, or both, the computing environment 200 can be used, at least in part, to embody or implement the data center.

The computing device 202 can include at least one processing system, for example, having at least one processor 204 and at least one memory 206, both of which can be communicatively coupled, operatively coupled, or both, to a local interface 208. The memory 206 can include a data store 210, an RL agent module 212, a prediction module 214, an optimization module 216, a guidance module 218, a communications stack 220, and a control module 222 in the example shown. The computing device 202 can also be communicatively coupled, operatively coupled, or both, by way of the local interface 208 to one or more control systems 224 (hereinafter, “the control systems 224”) of the computing environment 200. The computing environment 200 and the computing device 202 can also include other components that are not illustrated in FIG. 2.

In some cases, the computing environment 200, the computing device 202, or both may or may not include all the components illustrated in FIG. 2. For example, in some cases, depending on how the computing environment 200 is embodied or implemented, the computing environment 200 may or may not include the control systems 224, and thus, the computing device 202 may or may not be coupled to the control systems 224. Also, in some cases, depending on how the computing device 202 is embodied or implemented, the memory 206 may or may not include the RL agent module 212, the prediction module 214, the optimization module 216, the guidance module 218, the communications stack 220, the control module 222, any combination thereof, or other components. For instance, in an embodiment where any or all of the computing devices 114, 116, 118, 120 offload their entire optimization-based RL processing workload to the computing device 112, any or all of such devices may not include at least one of the RL agent module 212, the prediction module 214, the optimization module 216, or the guidance module 218.

The processor 204 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 204 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 206 can be embodied as one or more memory devices and store data and software or executable-code components executable by the processor 204. For example, the memory 206 can store executable-code components associated with the RL agent module 212, the prediction module 214, the optimization module 216, the guidance module 218, the communications stack 220, and the control module 222 for execution by the processor 204. The memory 206 can also store data such as the data described below that can be stored in the data store 210, among other data. For instance, the memory 206 can also store at least one of the subsystem data 126, 128, 130 or the policy data 134, 136, 138, 140.

The memory 206 can store other executable-code components for execution by the processor 204. For example, an operating system can be stored in the memory 206 for execution by the processor 204. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 206 can store software for execution by the processor 204. In this respect, the terms “executable” or “for execution” refer to software forms that can ultimately be run or executed by the processor 204, whether in source, object, machine, or other form. Examples of executable programs include, for instance, a compiled program that can be translated into a machine code format and loaded into a random access portion of the memory 206 and executed by the processor 204, source code that can be expressed in an object code format and loaded into a random access portion of the memory 206 and executed by the processor 204, source code that can be interpreted by another executable program to generate instructions in a random access portion of the memory 206 and executed by the processor 204, or other executable programs or code.

The local interface 208 can be embodied as a data bus with an accompanying address/control bus or other addressing, control, and/or command lines. In part, the local interface 208 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 210 can include data for the computing device 202 such as, for instance, one or more unique identifiers for the computing device 202, digital certificates, encryption keys, session keys and session parameters for communications, and other data for reference and processing. The data store 210 can also store computer-readable instructions for execution by the computing device 202 via the processor 204, including instructions for the RL agent module 212, the prediction module 214, the optimization module 216, the guidance module 218, the communications stack 220, and the control module 222. In some cases, the data store 210 can also store at least one of the subsystem data 126, 128, 130 or the policy data 134, 136, 138, 140.

The RL agent module 212 can be embodied as one or more software applications or services executing on the computing device 202. The RL agent module 212 can be executed by the processor 204 to learn how to adapt the optimization module 216 using one or more policies generated by the optimization module 216 based on real-world conditions. In this way, the RL agent module 212 can thereby allow for any of the computing devices 112, 114, 116, 118, 120 to learn how to adapt the optimization module 216 using one or more policies generated by the optimization module 216 based on real-world conditions.

The RL agent module 212 can learn how to adapt the optimization module 216 such that any of the subsystems 104, 106, 108, 110 can perform sequential decision-making operations individually or collectively based on real-world conditions while achieving a defined level of at least one of individual or collective efficiency. In one example, the RL agent module 212 can use multiple, different policies generated by the optimization module 216 to learn how to adapt the optimization module 216 based on observed states of any of the subsystems 104, 106, 108, 110. In this example, the observed states are observed after the subsystems 104, 106, 108, 110 perform such sequential decision-making operations individually or collectively based on at least one recommended action of at least one of the different policies.

The RL agent module 212 can also learn how to adapt the optimization module 216 based on at least one of the subsystem data 124, 126, 128, 130 of at least one of the subsystems 104, 106, 108, 110 by iteratively adjusting or tuning one or more parameters of the optimization module 216 based on at least one of the subsystem data 124, 126, 128, 130. In this way, the RL agent module 212 can learn a set of parameters and corresponding parameter values that allow the optimization module 216 to define a policy of one or more suggested actions for sequential decision-making operations such that at least one of the subsystems 104, 106, 108, 110 can individually or collectively perform these operations while achieving a defined level of at least one of individual or collective efficiency.

In one example, the RL agent module 212 can perform the above-described learning operations by implementing a Markov decision process (MDP). For instance, the RL agent module 212 can perform such learning operations by implementing an MDP using a solution function of the optimization module 216 as policy as described above with reference to the example depicted in FIG. 1. In some examples, the RL agent module 212 can include, be embodied, or implemented as at least one of a machine learning (ML) model, an artificial intelligence (AI) model, or another model.

In at least one example, to facilitate performance of the above-described learning operations, the RL agent module 212 can operate in conjunction with at least one of the prediction module 214, the optimization module 216, or the guidance module 218. For instance, based on obtaining an observed state corresponding to a particular subsystem such as the subsystem 104, the RL agent module 212 can calculate and issue a reward or penalty to the prediction module 214 based on the observed state. The prediction module 214 can then predict at least one predicted future state of the subsystem 104 based on at least one of the observed state, the reward, or the penalty. The prediction module 214 can further provide the at least one predicted future state to the optimization module 216.

In the example above, the RL agent module 212 can use a guidance signal generated by the guidance module 218 to define, at least in part, an updated parameter value for one or more respective parameters of the optimization module 216. The RL agent module 212 can also define the updated parameter value, at least in part, based on at least one of the observed state, the reward, or the penalty. The guidance module 218 can generate the guidance signal based on domain-specific data associated with the subsystem 104.

The RL agent module 212 or the optimization module 216 can use the updated parameter value to adjust (tune) the one or more respective parameters of the optimization module 216 to update the optimization module 216. The optimization module 216 can then generate a policy based on the updated parameter value and the at least one predicted future state of the subsystem 104 that was predicted by the prediction module 214 as described above. The policy generated by the optimization module 216 can include one or more suggested actions for sequential decision-making operations that can be performed by the subsystem 104 to achieve a defined goal. For instance, the one or more suggested actions can be recommended actions that are to be performed by the subsystem 104 when it performs the sequential decision-making operations. In one example, the one or more suggested actions can be defined with the objective of augmenting the performance of the sequential decision-making operations by the subsystem 104 such that the subsystem 104 can achieve a defined goal when performing such operations.

In one example, for the RL agent module 212 to learn a policy that allows the subsystem 104 to achieve a defined goal when performing sequential decision-making operations, the above-described operations performed by the RL agent module 212, the prediction module 214, the optimization module 216, and the guidance module 218 can be repeated iteratively. For instance, the above-described operations can be repeated iteratively using observed states of the subsystem 104 that can each be observed after the subsystem 104 implements at least one recommended action defined in a new policy generated by the optimization module 216. A new policy can be generated by the optimization module 216 at each iteration based in part on one or more newly updated parameter values that have been defined by the RL agent module 212 and the guidance module 218 as described above for each iteration. The new policy generated at each iteration can also be generated based in part on one or more newly predicted future states of the subsystem 104 that have been predicted by the prediction module 214 for each iteration.

In the example above, based on multiple iterations of the above-described operations, the RL agent module 212 can learn at least one parameter value of one or more parameters of the optimization module 216 that cause the optimization module 216 to generate a policy that allows the subsystem 104 to achieve a defined goal when performing sequential decision-making operations. In this way, by learning the at least one parameter value of the one or more parameters of the optimization module 216, the RL agent module 212 can thereby effectively learn the policy that allows the subsystem 104 to achieve a defined goal when performing sequential decision-making operations. Similarly, by learning the policy, the RL agent module 212 can thereby effectively learn the at least one parameter value of the one or more parameters of the optimization module 216 that cause the optimization module 216 to generate the policy.

The prediction module 214 can be embodied as one or more software applications or services executing on the computing device 202. The prediction module 214 can be executed by the processor 204 to predict one or more predicted future states of any of the subsystems 104, 106, 108, 110. For instance, with respect to any one of the subsystems 104, 106, 108, 110, such as, for example, the subsystem 104, the prediction module 214 can predict each predicted future state of the subsystem 104 based on an observed state of the subsystem 104 and a reward or penalty that has been issued to the prediction module 214 by the RL agent module 212 based on the observed state. In this example, the observed state can be a current state of the subsystem 104 that can be observed after the subsystem 104 performs one or more sequential decision-making operations based on at least one recommended action in a policy generated by the optimization module 216.

In some cases, the prediction module 214 can predict the one or more predicted future states of the subsystem 104 based on at least one observed state of at least one of the subsystems 106, 108, 110. For instance, the prediction module 214 can predict such one or more predicted future states of the subsystem 104 based on at least one of the subsystem data 126, 128, 130.

The prediction module 214 can include, be embodied, or implemented as at least one of an ML model, an AI model, or another model. In one example, the prediction module 214 can include, be embodied, or implemented as a regression model, a classification model, another ML or AI model, or a combination thereof.

The optimization module 216 can be embodied as one or more software applications or services executing on the computing device 202. The optimization module 216 can be executed by the processor 204 to generate a policy by defining one or more suggested actions for sequential decision-making operations that are to be performed by a subsystem such as, for instance, the subsystem 104 to achieve a defined goal. As described above, the optimization module 216 can define one or more suggested actions, and thereby define a policy, based in part on one or more parameter values of the optimization module 216 that can be defined by the RL agent module 212 and the guidance module 218. The optimization module 216 can also define one or more suggested actions, and thereby define a policy, based in part on at least one predicted future state of the subsystem 104 that has been predicted by the prediction module 214 as described above.

As described above, the one or more parameter values that can be defined by the RL agent module 212 and the guidance module 218 can correspond to one or more parameters of the optimization module 216. Examples of such one or more parameters can include a hyperparameter, a constraint parameter, a solution function parameter, an objective function parameter, or another parameter. Examples of the constraint parameter can include a technological constraint parameter, a physical constraint parameter, a domain-specific constraint parameter, a social constraint parameter, or another constraint parameter. In one example, the constraint parameter or parameters can be at least one of an energy storage capacity constraint parameter, an energy charging constraint parameter, an energy discharging constraint parameter, an efficiency constraint parameter, or another constraint parameter.

The optimization module 216 can include, be embodied, or implemented as at least one of an ML model, an AI model, or another model. In one example, the optimization module 216 can include, be embodied, or implemented as a convex optimization model.

The guidance module 218 can be embodied as one or more software applications or services executing on the computing device 202. The guidance module 218 can be executed by the processor 204 to generate a guidance signal based on domain-specific data to augment the identification of the relatively best (or optimized) parameter value or values that should be used to update the optimization module 216. To generate the guidance signal, the guidance module 218 can operate in conjunction with the RL agent module 212 to evaluate various parameter values of various parameters of the optimization module 216. In one example, to generate the guidance signal, the guidance module 218 can use data output by the RL agent module 212 as a result of performing an initial evaluation of one or more parameter values. For instance, the guidance module 218 can apply domain-specific data to the data output by the RL agent module 212 following such an initial evaluation to further facilitate the identification and selection by the RL agent module 212 of the relatively best (optimized) parameter value or values.

The RL agent module 212 can perform an initial evaluation of various parameter value candidates for various parameters of the optimization module 216 based on action-state-performance trajectory data that respectively corresponds to each parameter value candidate. In other words, for each parameter value candidate, the RL agent module 212 can evaluate the ramifications of a corresponding policy that would be generated by the optimization module 216 if the parameter value candidate were to be used to update the optimization module 216. For example, for each parameter value candidate, the RL agent module 212 can evaluate a projected policy action, a projected observed state of a subsystem such as the subsystem 104, and a projected reward or penalty that could result from using the parameter value candidate to update the optimization module 216.

In some cases, the RL agent module 212 can perform the above-described evaluation of different parameter value candidates iteratively. For instance, the RL agent module 212 can perform such an evaluation after each action-state-performance iteration of a subsystem such as the subsystem 104 to determine which of such candidates should be used to update the optimization module 216 for the next iteration. Here, the action-state-performance iteration refers to the cyclical process of generating a policy having an action that is performed by a subsystem described herein, then observing the state of the subsystem after it performs the action, and generating a reward or penalty based on the subsystem's performance of the action.

In some cases, by performing the above-described evaluation of different parameter value candidates, the RL agent module 212 can identify multiple parameter value candidates that should be used to update the optimization module 216. For instance, the RL agent module 212 can identify multiple parameter value candidates that each correspond to a particular parameter of the optimization module 216. In this example, the RL agent module 212 can select the relatively best candidate of such candidates, use an averaged value of such candidates, or use another criterion or calculation to identify a parameter value that should be used to update that particular parameter of the optimization module 216. In another example, the RL agent module 212 can identify multiple parameter value candidates that respectively correspond to different parameters of the optimization module 216. In this example, the RL agent module 212 can use one or more of such candidates to respectively update one or more of such different parameters.

After the RL agent module 212 performs the above-described initial evaluation of various parameter value candidates, the guidance module 218 can then use a guidance function based on domain-specific data to determine which of such candidates should be used to update the optimization module 216. The guidance module 218 can implement the guidance function based on action-state-performance trajectory data corresponding to each parameter value candidate. For instance, the guidance module 218 can implement the guidance function based on action-state-performance trajectory data corresponding to each of the relatively best parameter value candidates identified by the RL agent module 212 in its initial evaluation described above.

The guidance module 218 can implement the guidance function to augment the above-described initial evaluation of various parameter value candidates by adding domain-specific data to such an evaluation. More specifically, the guidance module 218 can implement the guidance function to augment such an initial evaluation of different parameter value candidates by accounting for domain-specific data corresponding to each of such candidates. For instance, for each parameter value candidate, the guidance module 218 can implement the guidance function to account for domain-specific data associated with at least one of a certain sequential decision-making system or subsystem thereof in which the parameter value candidate would be used. In one example, the guidance module 218 can implement the guidance function to account for domain-specific data associated with at least one of the centralized sequential decision-making system 102a, the decentralized sequential decision-making system 102b, or any of the subsystems 104, 106, 108, 110. In some cases, the domain-specific data can include data or information learned by an entity that is considered to be an expert is such a domain.

By accounting for such domain-specific data described above, the guidance function implemented by the guidance module 218 can effectively limit the size of a parameter value search space from which various parameter value candidates are evaluated. For instance, by accounting for such domain-specific data, the guidance function can effectively limit the number of parameter value candidates that are fully evaluated during the entire evaluation process. In this way, the guidance function can allow the RL agent module 212 to define and learn parameter values of the optimization module 216 in a relatively efficient manner, thereby reducing the time and computational costs associated with performing such operations. Further, the guidance function can allow the RL agent module 212 to define and learn, in a relatively efficient and computationally inexpensive manner, the relatively best (optimized) parameter values of the optimization module 216 that optimize sequential decision-making operations performed by any of the subsystems 104, 106, 108, 110 with respect to a defined goal.

In one example, the RL agent module 212 and the guidance module 218 can collectively implement an evolutionary search algorithm to perform the full evaluation of various parameter value candidates as described above and to determine which of such candidates should be used to update the optimization module 216. The evolutionary search algorithm can perform such an end-to-end evaluation and make such a determination based on action-state-performance trajectory data respectively corresponding to each parameter value candidate. The evolutionary search algorithm can use the above-described guidance function to evaluate such various parameter value candidates based on the domain-specific data described above.

In some cases, the RL agent module 212 and the guidance module 218 can collectively implement the above-described evolutionary search algorithm iteratively. For instance, the RL agent module 212 and the guidance module 218 can collectively implement the evolutionary search algorithm after each action-state-performance iteration of a subsystem such as the subsystem 104 to determine which parameter value candidate or candidates should be used to update the optimization module 216 for the next iteration.

In some cases, one or more of the RL agent module 212, the prediction module 214, the optimization module 216, and the guidance module 218 can perform their respective operations independent of one another. In other cases, two or more of the RL agent module 212, the prediction module 214, the optimization module 216, and the guidance module 218 can perform such operations collectively, for instance, in conjunction and/or as a single unit.

In some examples, one or more of the RL agent module 212, the prediction module 214, the optimization module 216, and the guidance module 218 can perform their respective operations using one or more of the methodologies, equations, and algorithms described in “APPENDIX A” of U.S. Provisional Patent Application No. 63/318,988, the entire contents of which is incorporated herein by reference. In one example, the RL agent module 212 and the guidance module 218 can perform their operations in conjunction and/or as a single unit by implementing the methodology described in connection with Equations (1) to (10) and Algorithm 1 set forth in Section 3, titled “Methodology” in “APPENDIX A.”

More specifically, in one example, the RL agent module 212 can operate in conjunction with at least one of the prediction module 214, the optimization module 216, or the guidance module 218 to perform the above-described optimization-based RL process, including the evaluation of various parameter value candidates, by implementing the methodology described in connection with Equations (1) to (10) and Algorithm 1 set forth in Section 3, titled “Methodology” in “APPENDIX A.” Additionally, APPENDIX A in the U.S. Provisional Patent Application No. 63/318,988 also includes a proof of how the RL agent module 212 and the guidance module 218 can be implemented to converge on at least one of a set of optimized (relatively best) local parameter values or a set of optimized (relatively best) global parameter values for a single subsystem or multiple subsystems, respectively, in a sequential decision-making system.

In some examples, one or more of the RL agent module 212, the prediction module 214, the optimization module 216, and the guidance module 218 can perform their respective operations using one or more of the methodologies, equations, and algorithms described in the paper titled “WINNING THE CITYLEARN CHALLENGE: ADAPTIVE OPTIMIZATION WITH EVOLUTIONARY SEARCH UNDER TRAJECTORY-BASED GUIDANCE,” by Vanshaj Khattar and Ming Jin, published Dec. 4, 2022, at arXiv:2212.01939, arXiv:2212.01939v1, and https://doi.org/10.48550/arXiv.2212.01939, the entire contents of which is hereby incorporated herein by reference. In one example, the RL agent module 212 and the guidance module 218 can perform their operations in conjunction and/or as a single unit by implementing the methodology described in connection with Equations (1) to (7) and Algorithm 1 set forth in Sections 2 and 3, respectively titled “Preliminaries” and “Policy Adaptation With ES Under Guidance” in the paper titled “WINNING THE CITYLEARN CHALLENGE: ADAPTIVE OPTIMIZATION WITH EVOLUTIONARY SEARCH UNDER TRAJECTORY-BASED GUIDANCE.”

More specifically, in one example, the RL agent module 212 can operate in conjunction with at least one of the prediction module 214, the optimization module 216, or the guidance module 218 to perform the above-described optimization-based RL process, including the evaluation of various parameter value candidates, by implementing the methodology described in connection with Equations (1) to (7) and Algorithm 1 set forth in Sections 2 and 3, respectively titled “Preliminaries” and “Policy Adaptation With ES Under Guidance” in the paper titled “WINNING THE CITYLEARN CHALLENGE: ADAPTIVE OPTIMIZATION WITH EVOLUTIONARY SEARCH UNDER TRAJECTORY-BASED GUIDANCE.” Additionally, the paper titled “WINNING THE CITYLEARN CHALLENGE: ADAPTIVE OPTIMIZATION WITH EVOLUTIONARY SEARCH UNDER TRAJECTORY-BASED GUIDANCE” also includes a proof of how the RL agent module 212 and the guidance module 218 can be implemented to converge on at least one of a set of optimized (relatively best) local parameter values or a set of optimized (relatively best) global parameter values for a single subsystem or multiple subsystems, respectively, in a sequential decision-making system.

The communications stack 220 can include software and hardware layers to implement data communications such as, for instance, Bluetooth®, BLE, WiFi®, cellular data communications interfaces, or a combination thereof. Thus, the communications stack 220 can be relied upon by each of the computing devices 112, 114, 116, 118, 120 to establish cellular, Bluetooth®, WiFi®, and other communications channels with the networks 122 and with one another.

The communications stack 220 can include the software and hardware to implement Bluetooth®, BLE, and related networking interfaces, which provide for a variety of different network configurations and flexible networking protocols for short-range, low-power wireless communications. The communications stack 220 can also include the software and hardware to implement WiFi® communication, and cellular communication, which also offers a variety of different network configurations and flexible networking protocols for mid-range, long-range, wireless, and cellular communications. The communications stack 220 can also incorporate the software and hardware to implement other communications interfaces, such as X10®, ZigBee®, Z-Wave®, and others. The communications stack 220 can be configured to communicate various data amongst the computing devices 112, 114, 116, 118, 120 such as, for instance, the subsystem data 124, 126, 128, 130 and the policy data 134, 136, 138, 140 according to examples described herein.

The control module 222 can be embodied as one or more software applications or services executing on the computing device 202. The control module 222 can be executed by the processor 204 to cause any of the control systems 224 to perform one or more operations to facilitate various control functions of any of the subsystems 104, 106, 108, 110. For example, the control module 222 can be implemented to cause any of the control systems 224 to perform one or more control operations in connection with and/or to facilitate the above-described sequential decision-making operations that can be performed individually or collectively by the subsystems 104, 106, 108, 110. In at least one example, the control module 222 can be implemented to cause any of the control systems 224 to perform such control operations based on, for instance, one or more recommended actions defined in one or more policies generated by the optimization module 216 and other information in some cases (e.g., sensor data or other data of one or more other systems or computing devices).

The control systems 224 can be embodied as one or more control systems that can be included in or coupled (e.g., communicatively, operatively) to and used by any of the subsystems 104, 106, 108, 110. The control systems 224 can be configured and operable to perform control functions for any of the subsystems 104, 106, 108, 110 such as, for instance, automated or semi-automated control functions. In one example, the control systems 224 can be configured and operable to perform various control operations based on receipt of instructions from the control module 222 as described above. For example, the control systems 224 can be configured and operable to perform such control operations based on receipt of instructions generated by the control module 222 in response to one or more recommended actions defined in one or more policies generated by the optimization module 216 and other information in some cases (e.g., sensor data or other data of one or more other systems or computing devices).

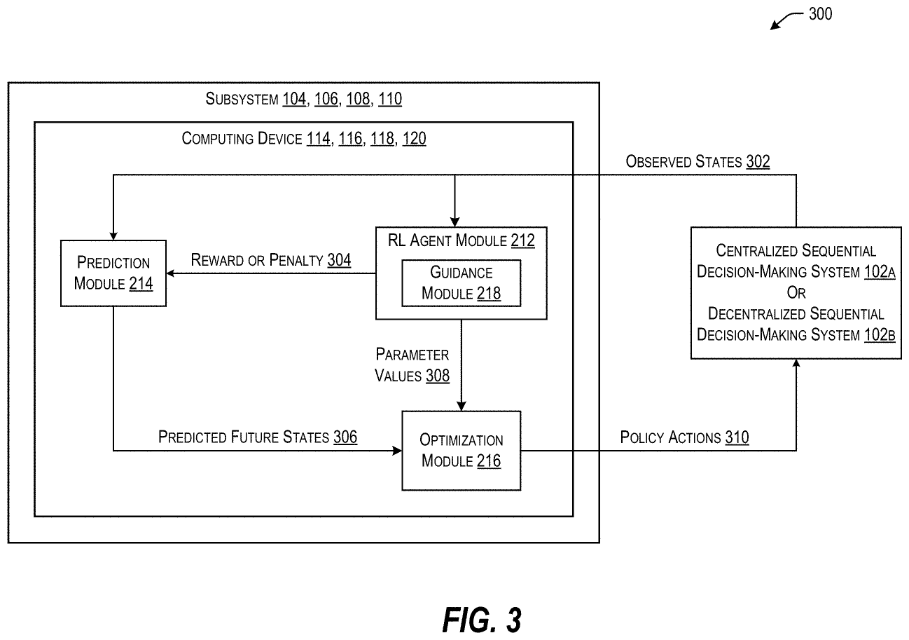

FIG. 3 illustrates an example data flow 300 that can be implemented to facilitate reinforcement learning with optimization-based policy for a sequential decision-making system according to at least one embodiment of the present disclosure. The data flow 300 illustrates the flow of various data during each of the action-state-performance iterations that facilitate the optimization-based RL operations described above with reference to the example illustrated in FIG. 2.

In the example depicted in FIG. 3, to facilitate performance of the above-described optimization-based RL operations, the RL agent module 212 can obtain one or more observed states 302 (hereinafter, “the observed states 302”) corresponding to any of the subsystems 104, 106, 108, 110 such as the subsystem 104 in this example. The RL agent module 212 can then use the observed states 302 to calculate and issue a reward or penalty 304 to the prediction module 214 based on the observed states 302. The prediction module 214 can then predict one or more predicted future states 306 (hereinafter, “the predicted future states 306”) of the subsystem 104 based on at least one of the observed states 302 or the reward or penalty 304. The prediction module 214 can further provide the predicted future states 306 to the optimization module 216.

In the example illustrated in FIG. 3, the RL agent module 212 can include the guidance module 218. The RL agent module 212 can use the above-described guidance signal that can be generated by the guidance module 218 to define, at least in part, one or more parameter values 308 (hereinafter, “the parameter values 308”) for one or more respective parameters of the optimization module 216. The RL agent module 212 can also define the parameter values 308, at least in part, based on at least one of the observed states 302 or the reward or penalty 304. The guidance module 218 can generate the guidance signal based on domain-specific data associated with the subsystem 104 as described above with reference to the example illustrated in FIG. 2.

In the example depicted in FIG. 3, the RL agent module 212 or the optimization module 216 can use the parameter values 308 to adjust or tune the one or more respective parameters of the optimization module 216 to update the optimization module 216. The optimization module 216 can then generate a policy having one or more policy actions 310 (hereinafter, “the policy actions 310”) based on the parameter values 308 and the predicted future states 306. The policy actions 310 can include one or more suggested actions for sequential decision-making operations that can be performed by the subsystem 104 in this example to achieve a defined goal. For instance, the policy actions 310 can be recommended actions that are to be performed by the subsystem 104 in the centralized sequential decision-making system 102a when it performs the sequential decision-making operations. In one example, the policy actions 310 can be defined with the objective of augmenting the performance of the sequential decision-making operations by the subsystem 104 in the centralized sequential decision-making system 102a such that the subsystem 104 can achieve a defined goal when performing such operations.

Although the data flow 300 is described above with respect to the subsystem 104 and the centralized sequential decision-making system 102a, the data flow 300 is not so limiting. For instance, the data flow 300 can also be implemented with respect to any of the subsystems 106, 108, 110 and the decentralized sequential decision-making system 102b in the same manner as described above.

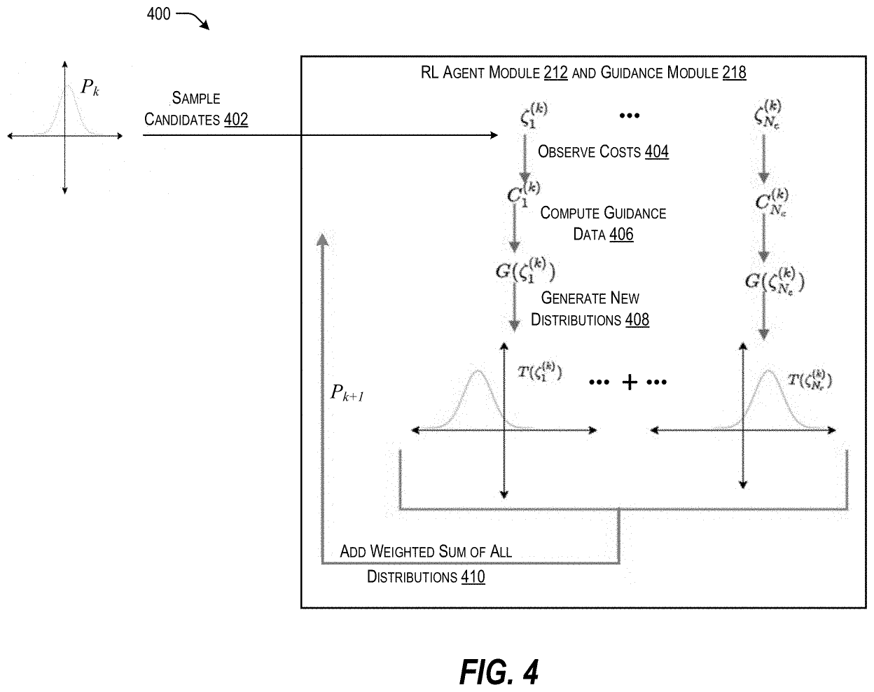

FIG. 4 illustrates a diagram of example parameter value exploration operations 400 that can be implemented by the RL agent module 212 and the guidance module 218 to facilitate reinforcement learning with optimization-based policy for a sequential decision-making system according to at least one embodiment of the present disclosure. In the example depicted in FIG. 4, the parameter value exploration operations 400 correspond to the operations that can be performed by implementing Algorithm 1 described in “APPENDIX A” of U.S. Provisional Patent Application No. 63/318,988. In this example, the RL agent module 212 and the guidance module 218 can perform the parameter value exploration operations 400 in the same manner as described in Algorithm 1 in “APPENDIX A.”

In one example, the parameter value exploration operations 400 can be implemented by the computing device 112 (e.g., the computing device 202). In another example, the parameter value exploration operations 400 can be implemented by any of the subsystems 104, 106, 108, 110 using, for instance, their respective computing device 114, 116, 118, 120 (e.g., the computing device 202). The parameter value exploration operations 400 can be implemented in the context of the environment 100, the computing environment 200 or another environment, and the data flow 300.

In the example depicted in FIG. 4, the RL agent module 212 can randomly sample one or more sample candidates at 402 (hereinafter, “the sample candidates”) from a distribution Pₖ for exploration. The RL agent module 212 can then observe costs at 404 for each of the sample candidates. The guidance module 218 can then use the above-described guidance function to compute guidance data at 406 for each of the sample candidates based on the above-described domain-specific data. The RL agent module 212 can then generate new distributions at 408 for each of the sample candidates based on the guidance data generated by the guidance module 218 at 406. After completing the above operations for each of the sample candidates, the RL agent module 212 can add the weighted sums of all distributions at 410.

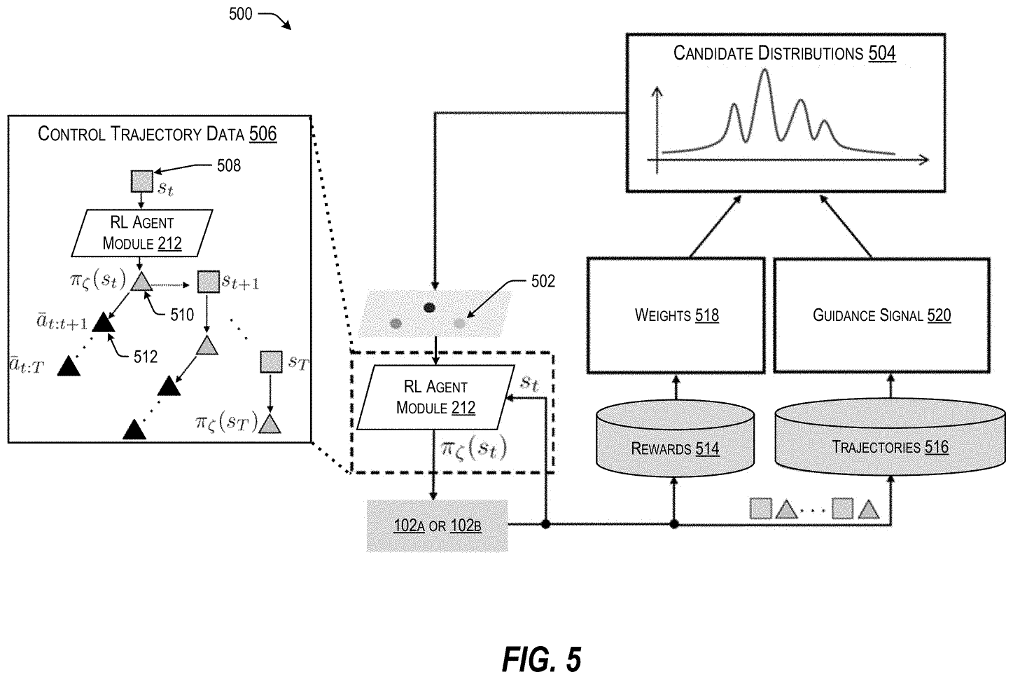

FIG. 5 illustrates a block diagram of an example adaptive optimization system 500 that can facilitate reinforcement learning with optimization-based policy for a sequential decision-making system according to at least one embodiment of the present disclosure. In the example depicted in FIG. 5, the adaptive optimization system 500 can implement the methodology described in connection with Equations (1) to (7) and Algorithm 1 set forth in Sections 2 and 3, respectively titled “Preliminaries” and “Policy Adaptation With ES Under Guidance” in the paper titled “WINNING THE CITYLEARN CHALLENGE: ADAPTIVE OPTIMIZATION WITH EVOLUTIONARY SEARCH UNDER TRAJECTORY-BASED GUIDANCE.”

In one example, the adaptive optimization system 500 can be implemented by the computing device 112 (e.g., the computing device 202). In another example, the adaptive optimization system 500 can be implemented by any of the subsystems 104, 106, 108, 110 using, for instance, their respective computing device 114, 116, 118, 120 (e.g., the computing device 202). The adaptive optimization system 500 can be implemented in the context of the environment 100, the computing environment 200 or another environment, and the data flow 300.

FIG. 5 illustrates an example of how a subsystem such as the subsystem 104 can iteratively implement the adaptive optimization system 500 to adapt optimization parameters of the optimization module 216 using the RL agent module 212 and the guidance module 218. At each iteration of the adaptive optimization system 500, the RL agent module 212 can evaluate one or more policy candidates 502 (e.g., three in this case) sampled from candidate distributions 504. In performing such an evaluation, the RL agent module 212 can generate control trajectory data 506 (e.g., state-action trajectory data) for each of the policy candidates 502 based on observed states 508 (denoted as grey squares, only one denoted in FIG. 5 for clarity). In the example depicted in FIG. 5, the observed states 508 can be observed states of the subsystem 104, which can be observed in the centralized sequential decision-making system 102a in this example and fed back to the RL agent module 212.

The control trajectory data 506 can include the trajectory of the observed states 508, actual actions 510 (denoted as grey triangles, only one denoted in FIG. 5 for clarity), and planned actions 512 (denoted as black triangles, only one denoted in FIG. 5 for clarity). At each step, the RL agent module 212 can solve an optimization equation to plan ahead, while only executing the most immediate action of the planned actions 512. For example, the RL agent module 212 can solve Equation (2) set forth in Section 2 titled “Preliminaries” in the paper titled “WINNING THE CITYLEARN CHALLENGE: ADAPTIVE OPTIMIZATION WITH EVOLUTIONARY SEARCH UNDER TRAJECTORY-BASED GUIDANCE.”

Observed rewards 514 and trajectories 516 of the control trajectory data 506 can be stored in respective buffers (e.g., buffers in the memory 206). The rewards 514 and the trajectories 516 can then be used by the RL agent module 212 and the guidance module 218 to compute weights 518 and guidance signals 520 to update the candidate distributions 504.

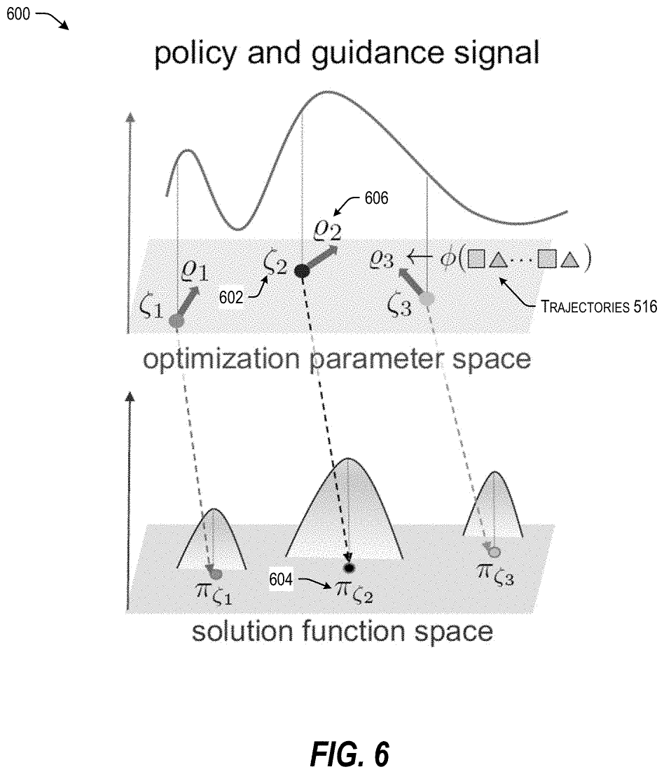

FIG. 6 illustrates an example correspondence diagram 600 according to at least one embodiment of the present disclosure. In the example depicted in FIG. 6, the correspondence diagram 600 is described in further detail in connection with Sections 2 and 3, respectively titled “Preliminaries” and “Policy Adaptation With ES Under Guidance” in the paper titled “WINNING THE CITYLEARN CHALLENGE: ADAPTIVE OPTIMIZATION WITH EVOLUTIONARY SEARCH UNDER TRAJECTORY-BASED GUIDANCE.”

The two-level structure of the correspondence diagram 600 indicates the correspondence between an optimization parameter 602 (only one denoted in FIG. 6 for clarity) and a solution function 604 (only one denoted in FIG. 6 for clarity), which is used as policy in examples described herein. The upper-level objective is the expected episodic rewards, and the lower-level objective is an objective function, the extremum of which is the policy action. A guidance signal 606 (only one denoted in FIG. 6 for clarity) can be computed by the guidance module 218 based on the trajectory 516 of each candidate and applied on top of the original parameter by at least one of the RL agent module 212 or the guidance module 218 during the update of the optimization module 216.

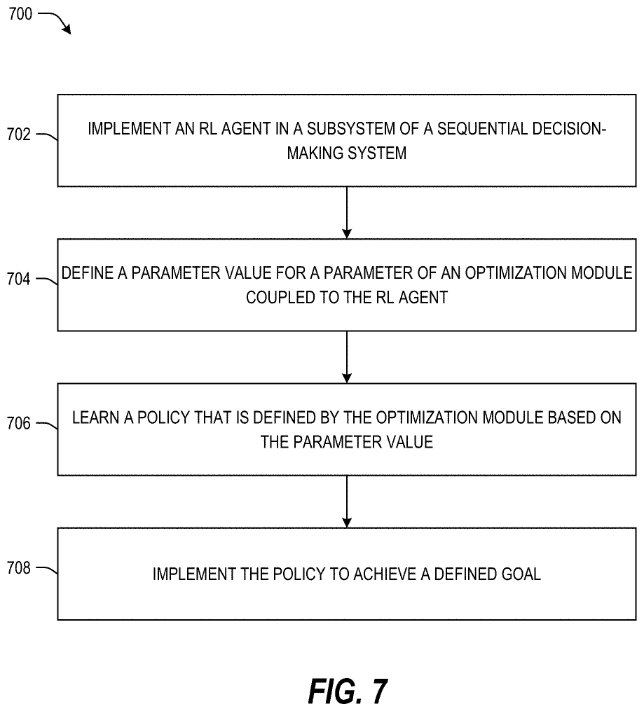

FIG. 7 illustrates a flow diagram of an example computer-implemented method 700 that can be implemented to facilitate reinforcement learning with optimization-based policy for a sequential decision-making system according to at least one embodiment of the present disclosure. In one example, computer-implemented method 700 (hereinafter, “the method 700”) can be implemented by the computing device 112 (e.g., the computing device 202). In another example, the method 700 can be implemented by any of the subsystems 104, 106, 108, 110 using, for instance, their respective computing device 114, 116, 118, 120 (e.g., the computing device 202). The method 700 can be implemented in the context of the environment 100, the computing environment 200 or another environment, and the data flow 300.

At 702, method 700 can include implementing an RL agent in a subsystem of the sequential decision-making system. For example, the computing device 114 can implement the RL agent module 212 within and with respect to the subsystem 104 in the centralized sequential decision-making system 102a as described above with reference to the examples illustrated in FIGS. 1, 2 and 3.

At 704, method 700 can include defining a parameter value for a parameter of an optimization module coupled to the RL agent. For example, the computing device 114 can define the parameter values 308 for the optimization module 216 based on at least one of the subsystem data 124, the observed states 302, or the reward or penalty 304. For instance, the computing device 114 can define a parameter value of at least one of a hyperparameter, a constraint parameter, a solution function parameter, or an objective function parameter of the optimization module 216. In some cases, the computing device define the parameter value such as the parameter values 308 based on domain-specific data associated with at least one of the subsystem 104 or the centralized sequential decision-making system 102a.

At 706, method 700 can include learning a policy that is defined by the optimization module based on the parameter value. For example, the computing device 114 can learn a policy that is defined by the optimization module 216 based on the parameter value and a predicted future state of the subsystem 104 that is predicted by the prediction module 214 based on the reward. For instance, the computing device 114 can learn the policy actions 310 that can be defined by the optimization module 216 based on the parameter values 308 and the predicted future states 306.

At 708, method 700 can include implementing the policy to achieve a defined goal. For example, the computing device 114 can implement the policy actions 310 to cause the subsystem 104 to perform at least one of the policy actions 310 in the centralized sequential decision-making system 102a to achieve a defined level of efficiency in performing the at least on policy action 310. For instance, the computing device 114 can implement the control module 222 to employ the control systems 224 based on the policy actions 310. In this example, the computing device 114 can thereby cause the subsystem 104 to perform at least one of the policy actions 310 in the centralized sequential decision-making system 102a to achieve a defined level of efficiency in performing the at least on policy action 310.

Referring now to FIG. 2, an executable program can be stored in any portion or component of the memory 206. The memory 206 can be embodied as, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 206 can include both volatile and nonvolatile memory and data storage components. Volatile components are those that do not retain data values upon loss of power. Nonvolatile components are those that retain data upon a loss of power. Thus, the memory 206 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the RL agent module 212, the prediction module 214, the optimization module 216, the guidance module 218, the communications stack 220, and the control module 222 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 7, the flowchart or process diagram shown in FIG. 7 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 204. The machine code can be converted from the source code. Further, each block can represent, or be connected with, a circuit or a number of interconnected circuits to implement a certain logical function or process step.

Although the flowchart or process diagram shown in FIG. 7 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the RL agent module 212, the prediction module 214, the optimization module 216, the guidance module 218, the communications stack 220, and the control module 222 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 7. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method to provide reinforcement learning for a sequential decision-making system, comprising:
implementing, by a computing device, a reinforcement learning agent in a subsystem of the sequential decision-making system, the reinforcement learning agent being coupled to a prediction module and an optimization module of the subsystem;
defining, by the computing device, a parameter value of the optimization module based on at least one of an observed state of the subsystem or a reward provided to the prediction module based on the observed state;
learning, by the computing device, a policy that is defined by the optimization module based on the parameter value and a predicted future state of the subsystem that is predicted by the prediction module based on the reward, the policy comprising a suggested action to be performed by the subsystem to achieve a defined goal; and
implementing, by the computing device, the policy to cause the subsystem to perform the suggested action.

2. The method to provide reinforcement learning of claim 1, wherein implementing the reinforcement learning agent in the subsystem comprises:
implementing, by the computing device, the prediction module to predict the predicted future state based on the observed state and the reward; and
implementing, by the computing device, the optimization module to define the policy based on the parameter value and the predicted future state.

3. The method to provide reinforcement learning of claim 1, wherein defining the parameter value of the optimization module comprises:
defining, by the computing device, an objective function parameter value or a constraint parameter value of the optimization module.

4. The method to provide reinforcement learning of claim 1, wherein defining the parameter value of the optimization module comprises:
tuning, by the computing device, an objective function parameter or a constraint parameter of the optimization module to respectively define an objective function parameter value or a constraint parameter value of the optimization module.

5. The method to provide reinforcement learning of claim 1, wherein learning the policy comprises:
learning, by the computing device, the policy based on a second observed state corresponding to a second subsystem of the sequential decision-making system.

6. The method to provide reinforcement learning of claim 1, further comprising:
learning, by the computing device, a second policy corresponding to a second subsystem of the sequential decision-making system, the second policy respectively comprising a second suggested action to be performed by the second subsystem to achieve the defined goal.

7. The method to provide reinforcement learning of claim 1, further comprising:
learning, by the computing device, the parameter value based on domain-specific data associated with a domain of at least one of the sequential decision-making system or the subsystem.

8. The method to provide reinforcement learning of claim 1, further comprising:
implementing, by the computing device, an evolutionary search algorithm that uses a guidance function to define the parameter value based on domain-specific data associated with a domain of at least one of the sequential decision-making system or the subsystem.

9. The method to provide reinforcement learning of claim 1, wherein the sequential decision-making system comprises a distributed control system, and wherein implementing the policy to cause the subsystem to perform the suggested action comprises:
implementing, by the computing device, the policy in the distributed control system to cause the subsystem to perform the suggested action in the distributed control system.

10. The method to provide reinforcement learning of claim 1, wherein the optimization module comprises a convex optimization model.

11. A computing device, comprising:
a memory device to store computer-readable instructions thereon; and
at least one processing device configured through execution of the computer-readable instructions to:
implement a reinforcement learning agent in a subsystem of a sequential decision-making system, the reinforcement learning agent being coupled to a prediction module and an optimization module of the subsystem;
define a parameter value of the optimization module based on at least one of an observed state of the subsystem or a reward provided to the prediction module based on the observed state;
learn a policy that is defined by the optimization module based on the parameter value and a predicted future state of the subsystem that is predicted by the prediction module based on the reward, the policy comprising a suggested action to be performed by the subsystem to achieve a defined goal; and
implement the policy to cause the subsystem to perform the suggested action.

12. The computing device of claim 11, wherein, to implement the reinforcement learning agent in the subsystem, the at least one processing device is further configured to:
implement the prediction module to predict the predicted future state based on the observed state and the reward; and
implement the optimization module to define the policy based on the parameter value and the predicted future state.

13. The computing device of claim 11, wherein, to define the parameter value of the optimization module, the at least one processing device is further configured to:
define an objective function parameter value or a constraint parameter value of the optimization module.

14. The computing device of claim 11, wherein, to define the parameter value of the optimization module, the at least one processing device is further configured to:
tune an objective function parameter or a constraint parameter of the optimization module to respectively define an objective function parameter value or a constraint parameter value of the optimization module.

15. The computing device of claim 11, wherein, to learn the policy, the at least one processing device is further configured to:
learn the policy based on a second observed state corresponding to a second subsystem of the sequential decision-making system.

16. The computing device of claim 11, wherein the at least one processing device is further configured to:
learn a second policy corresponding to a second subsystem of the sequential decision-making system, the second policy comprising a second suggested action to be performed by the second subsystem to achieve the defined goal.

17. The computing device of claim 11, wherein the at least one processing device is further configured to:
learn the parameter value based on domain-specific data associated with a domain of at least one of the sequential decision-making system or the subsystem.

18. A non-transitory computer-readable medium embodying at least one program that, when executed by at least one computing device, directs the at least one computing device to:
implement a reinforcement learning agent in a subsystem of a sequential decision-making system, the reinforcement learning agent being coupled to a prediction module and an optimization module of the subsystem;
define a parameter value of the optimization module based on at least one of an observed state of the subsystem or a reward provided to the prediction module based on the observed state;
learn a policy that is defined by the optimization module based on the parameter value and a predicted future state of the subsystem that is predicted by the prediction module based on the reward, the policy comprising a suggested action to be performed by the subsystem to achieve a defined goal; and
implement the policy to cause the subsystem to perform the suggested action.

19. The non-transitory computer-readable medium according to claim 18, wherein, to implement the reinforcement learning agent in the subsystem, the at least one computing device is further directed to:
implement the prediction module to predict the predicted future state based on the observed state and the reward; and
implement the optimization module to define the policy based on the parameter value and the predicted future state.

20. The non-transitory computer-readable medium according to claim 18, wherein, to define the parameter value of the optimization module, the at least one computing device is further directed to:
define an objective function parameter value or a constraint parameter value of the optimization module.
